(19) United States
(12) Patent Application Publication
(10) Pub. No.: US 2026/0151740 A1
(43) Pub. Date: Jun. 4, 2026

(54) FILTRATION SYSTEM, METHOD FOR PREDICTING A MAINTENANCE CONDITION OF THE FILTRATION SYSTEM AND METHOD FOR PREDICTING A RECOVERY CONDITION OF THE FILTRATION SYSTEM

(71) Applicant: Roche Diagnostics Operations, Inc., Indianapolis, IN (US)

(72) Inventors: Carlos Munoz Rodriguez de Guzman, Penzberg (DE); Hans Zahn, Peiting (DE)

(21) Appl. No.: 19/122,626

(22) PCT Filed: Oct. 16, 2023
(86) PCT No.: PCT/EP2023/078619

§ 371 Date: Apr. 18, 2025

(30) Foreign Application Priority Data
Oct. 18, 2022 (EP) 22202293.1

(51) Int. Cl. B01D 65/08

(52) U.S. Cl. CPC B01D 65/08; B01D 2221/10; B01D 2315/10; B01D 2321/40

(57) ABSTRACT

A method for predicting a maintenance condition of a filtration system of a diagnostic apparatus or a laboratory analyser at a given time is done by performing the following steps. First a plurality of successive raw permeability values of the permeability of a fluid through the filtration device over a specified measurement period is measured. Then smoothed permeability values are determined by means of a data processing method to reduce the fluctuations of the raw permeability values over time. Afterwards a regression analysis function is applied through the successive permeability values, wherein the regression analysis function comprises fitting parameters being adapted so that the fitting function is fitted to the measured permeability values. Finally, the time, when the regression analysis function will cross a predetermined threshold value is determined, wherein the crossing of the threshold value is judged as a maintenance condition.

The invention relates to a filtration system, method for predicting a maintenance condition of the filtration system and a method for predicting a recovery condition of the filtration system.

The laboratory diagnostic industry uses reagents containing small particles having particle sizes smaller than 5 mm, e.g. nanoparticles and/or microparticles. The wastewater produced by this industry contains these small particles which are potentially harmful to the environment because of the materials from which they are made (e.g. microplastic). They also tend to be highly adsorbent and may cause damage because they can transfer contaminants to and from the environment. These particles differ from the particulate waste produced by other industries in that they have a well-defined composition and a highly uniform particle size. Accordingly, efficient removal of particles from the wastewater of a laboratory analyser is challenging.

Filtration techniques are often used to remove particles from liquids. Cross-flow filtration (also known as tangential flow filtration) is a type of filtration where the liquid for filtration is passed across a filter membrane, rather than directly into the filter as in dead-end filtration. Material in the liquid that is smaller than the pore size of the filter membrane will pass through the membrane to produce a permeate. The liquid is passed across the filter membrane at a positive pressure relative to the permeate side. It is this positive pressure that provides the main driving force for the cross-flow filtration process. The difference in pressure between the two sides of the filter membrane (known as the feed/retentate side and the permeate side) is measured as the transmembrane pressure (TMP).

Many cross-flow filtration processes involve a turbulent flow (e.g. a Reynolds number of about 2000 or more) of liquid being passed over the filter membrane. In such processes, the flow of liquid near the surface of the filter membrane is turbulent, which can prevent particulates from settling on the surface to form a filter cake that blocks the membrane's pores. Turbulent flows of liquid in cross-flow filtration are generally produced in filtration apparatus where the flow rate of the liquid is very high. Such flows are typically produced by pumps having a high-power output. These pumps tend to be large in size and have high energy consumption.

When cross-flow filtration is performed with a lower flow rate of liquid, then a laminar flow may pass over the surface of the filter membrane. Due to the low tangential flow velocity near the surface of the filter membrane associated with laminar flows, a problem is that the filter membrane is susceptible to becoming obstructed by particulates, such as when they agglomerate to form a filter cake on the surface of the filter membrane. When this happens, it is necessary to stop filtration to replace a blocked filter membrane with an unblocked one. Removal of obstructions from the filter membrane is necessary before it can be reused, but the process of removing obstructions can damage the membrane due to its delicate nature. This is undesirable because the filter membrane is an expensive part of the cross-flow filtration system.

Accordingly, attempts are made to delay such replacement procedures or maintenance tasks as long as possible.

However, the longer such maintenance tasks are delayed, the more likely it is that the filtration system will suddenly break down.

The filtration system must also be switched off to carry out these maintenance tasks, thereby delaying the filtration of the wastewater. This can lead to delays in analyses, which can increase production costs.

Therefore, it is important to evaluate the condition of the filtration system in order to minimize such downtime.

Traditionally, a filtration system is maintained at regular intervals. The condition of the filtration system is then only inspected during maintenance. In case of doubt, components that are prone to maintenance are replaced without even knowing the condition of the old components. This approach leads to frequent downtimes and unnecessary costs due to the replacement of components, such as the filter membrane, that is not required.

Therefore, it is an object of the present invention to provide a method for predicting a maintenance condition of a filter system, with which the maintenance condition can be reliably predicted in a simple manner.

A further object of the present invention is to provide a method for predicting a regeneration state of a filter system, which makes it possible to reliably predict in a simple manner when a regeneration of the filter system is necessary.

One or more objects are solved by the features of the independent claims. Advantageous further developments and preferred embodiments form the subject matter of the dependent claims.

A method for predicting a maintenance condition of a filtration system of a diagnostic apparatus or a laboratory analyser at a given time is done by performing the following steps. First, a plurality of successive raw permeability values of the permeability of a fluid through the filtration device over a specified measurement period is measured. Next, smoothed permeability values are determined by means of a data processing method to reduce the fluctuations of the raw permeability values over time. Afterwards, a regression analysis function is applied through the successive permeability values, wherein the regression analysis function comprises fitting parameters being adapted so that the fitting function is fitted to the measured permeability values. Finally, the time when the regression analysis function will cross a predetermined threshold value is determined, wherein the crossing of the threshold value is judged as a maintenance condition.

Smoothing the raw permeability values is a core step in the method to determine the maintenance condition. Filtration systems are often used in a non-continuous fashion. Breaks might occur e.g. at night or for holidays, at which no filtration is performed. It has been seen that during such breaks the permeability of the membrane revives so that the permeability value is increased. This causes unsteady changes in the raw permeability values. There are also further statistical effects which lead to an unsteady progression of the raw values. By smoothing the progression of the raw values it is possible to fit a steady function to the raw permeability values.

The revival of the membrane during the breaks is used in pulsed cycle modes to achieve an increased performance of the membrane. The permeability decreases at each active phase of each cycle. Due to the revival of the membrane during the breaks, the mean permeability value in a pulsed cycle mode is higher than the mean permeability value of the same system run in a continuous mode.

The downside is that the permeability rate over time has a sawtooth profile. A regression analysis function is hard to apply to such a sawtooth profile.

By smoothing the permeability values, the individual fluctuations caused by the filter system itself, for example by the cycles, are smoothed out and the decrease over a larger period of time, i.e. over several cycles in the case of a cyclical filter machine, is made more explicit.

The smoothing eliminates the characteristics of the sawtooth profile and other fluctuations of the raw permeability values.

This makes it possible to reliably determine the maintenance condition even for systems in a non-continuous mode, especially in a pulsed mode. Thus, the method can be used in a high throughput mode.

Even further, to determine a maintenance condition solely on the basis of one single cycle would result in a point in time that lies well before the actual failure of the machine. In this case, maintenance would be carried out too early.

The regression analysis can be used to determine the temporal progression of the permeability. This time progression in the form of a mathematical function can be used to determine when this mathematical function falls below a predetermined threshold value. The drop below the threshold indicates the maintenance condition.

A maintenance condition is a condition that means that maintenance should be carried out within a predetermined period of time, otherwise the filter system may fail within a certain period of time.

The threshold value and the time of a possible failure depend on each other. The lower the threshold value, the more likely a failure of the system is. The higher the threshold value, the less likely a system failure is. However, there is no guarantee that at a certain threshold value it will take a predetermined time until the system fails, as these are only average values of known system failures. Temporal fluctuations can occur. However, probabilities can be given that at a certain time interval it is likely that the system will fail up to a certain percentage.

The raw permeability values are measured permeability values of the filtration systems. However, the raw permeability values may themselves also be calculated, for example, from measured values of pressure, of a weight cell, of the power consumption of a pump, and/or from optical sensors.

The term “diagnostic apparatus” as used herein includes any such device or apparatus for performing a diagnostic function, which produces a wastewater comprising nanoparticles and/or microparticles. Diagnostic apparatuses are used to identify the nature or a cause of a certain phenomenon, particularly in the medical field where the information provided by the apparatus can help a clinician form a diagnosis about a patient's health. The diagnostic apparatus is preferably a medical diagnostic apparatus.

The term “laboratory analyser” as used herein includes any device or apparatus, typically an automated device or apparatus, for use in a laboratory to qualitatively identify the presence, or quantitatively determine an amount (e.g. typically a concentration), of a chemical or a substance in a sample, and which produces a wastewater comprising nanoparticles and/or microparticles. It is preferred that the laboratory analyser is a laboratory analyser for medical use (e.g. a medical laboratory analyser). The sample may, for example, be serum, plasma, urine or other bodily fluids from a human or animal patient. The substances for analysis or analytes that are be identified using the device or apparatus may include proteins, metabolites, electrolytes or drugs. The laboratory analyser may carry out a heterogeneous immunoassay. Examples of laboratory analysers include the cobas™ e 801 modules and the cobas™ c 701 modules produced by the present applicant.

Preferably, the smoothed permeability value is a moving average of the most recent two or more of the measured raw permeability values, which cover a duration of at least 1/1000, preferably at least 1/100, and preferably at least 1/10 of the average time the filtrating system is running until it has to be maintained.

The moving average of the last values is particularly suitable here for the calculation of the smoothed permeability value, since these can be calculated quickly and easily. A large computing power is not required here.

In principle, other methods are also conceivable, such as a moving low-pass filter.

When specifying how many values are averaged, it depends on the respective field filtration system. The longer a field filtration system operates without maintenance, the shorter the period that can be selected. Selecting a longer period allows for a more accurate the prediction. However, the longer the period, the greater the necessary computing effort due to the larger amount of data, so there may be delays in processing the data.

Optionally, the smoothed permeability value is a moving average of the most recent two or more of the measured raw permeability values, which may cover a duration of at least 1 minute, at least 1 day or at least 1 week.

The selected duration should not be too short, otherwise the regression analysis becomes inaccurate.

Advantageously, at least the last two steps, applying a regression analysis function and determining a maintenance condition, are performed, when the permeability value is lower than 90%, preferably lower than 70%, and preferably lower than 40%.

If the smoothed permeability value is lower than these values, it might be beneficial to run the filtration system in a pulsed cycle mode.

If it is not explicitly stated in the following description of the method for predicting a maintenance condition that the permeability values are the raw permeability values, the permeability values mean the smoothed permeability values.

It has surprisingly been found that by streaming the wastewater in pulsed cycles across the surface of the filter membrane, blockage of the filter membrane can be reduced or prevented during cross-flow filtration. This leads to a considerable improvement in the performance and efficiency of the cross-flow filtration technique. Cross-flow filtration can be carried out for longer periods of time, while maintaining a high flow rate of permeate through the filter membrane. It reduces the need for regularly stopping filtration to unblock and clear the filter membrane. It may also prolong the lifetime of the filter membrane.

For high permeability values, such as greater than 90%, it has been shown, that the prediction is too uncertain.

It has been shown that, if the permeate flow rate has fallen below these values, especially below 40%, the data becomes more stable and the slope flatter.

Optionally, at least the last two steps, applying a regression analysis function and determining a maintenance condition, are only performed, when the smoothed permeability values are greater than 5%, preferably higher than 10%, and preferably higher than 20%.

If, on the other hand, the smoothed permeability values are too low, in particular if they are less than 5%, less than 10%, or less than 20%, no amendment of the expected time when a maintenance condition exists is to be expected. An analysis here would only consume unnecessary resources by calculation.

Further, the method may be configured such that the regression analysis function is a fitting function.

A fitting function is defined as a particular embodiment of the regression analysis function, characterised in that it is based on the method of least squares. Such a function is already included in many software tools and the use of such a method is also commonly known. The implementation of such a method in the system is particularly easy here.

In principle, however, other functions of regression analysis are also possible, such as Bayesian methods, percentage regression, least absolute deviations, nonparametric regression, scenario optimization, or distance metric learning.

In embodiments, the regression analysis function is one or a combination of the following functions:
an exponential function, preferably: f(t)=a*exp(−b*t)+c,
a logarithmic function, preferably: f(t)=−a*In(−b*t)+c,
a linear function, preferably: f(t)=−a*t,
a quadratic function, preferably: f(t)=−a*t\hat{ }2,
a Taylor polynomial function, preferably of degree of at least 2, of at least 3, or of at least 4,
wherein t is the time and a, b and c are the fitting parameters.

These functions are particularly suitable for describing the trend of permeability values over time. Since they describe the trend of the permeability values particularly well, the functions here are also suitable for predicting the future trends and thus reliably indicating when a maintenance condition exists.

A method for predicting a recovery condition of a filtration system of a diagnostic apparatus or a laboratory analyser at a given time is done by performing the following steps. First, a plurality of successive permeability values of the permeability of a fluid through the filtration device over a specified measurement cycle are measured. Next, a regression analysis function through the successive permeability values, wherein the regression analysis function comprises fitting parameters being adapted so that the fitting function is fitted to the measured permeability values, is applied. Finally, it is determined by means of the fitting parameters whether a recovery condition is present.

A recovery condition indicates that a recovery of the filtration system, especially the membrane, is recommended. Ideally, the filtration system performs the recovery automatically.

During the filtration process particles may form a film on the membrane and block it. The more particles that are deposited on the filter's membrane, the greater the decay of permeability over time will be. The mean permeability decreases.

Permanent damage of the membrane could be caused by fouling processes. If there is a fouling process acting on the membrane and the concentration of particles is high, the particles cake formed on the membrane, which lead to a rapid blockage. The further the fouling process has evolved, the faster the membrane is blocked.

The recovery may be done by reversing the flow of the fluid.

The recovery may increase the permeate flow rate, extend the life of the filter and increase the time to the next maintenance.

During a recovery process the filtration system cannot be used to filter. Therefore, it is important to minimize the rate of recoveries and perform them when they are most efficient.

Fitting parameters are information about the general shape of the trend of permeability values over time. This shape can be used to draw conclusions about the need for recovery. The shape can be described by the fitting parameters.

If one or more of these parameters are in a predetermined range, this is an indication that the function describing the permeability indicates that a recovery is needed.

It has been shown that, depending on the chosen regression analysis function, one or more of the fitting parameters could correspond to a saturation of the filter's membrane.

Therefore, the behaviour of the one or more fitting parameters indicates the state of the membrane. A recovery condition is present when the parameter or parameters have reached a predetermined value or values. The analysis of the fitting parameter may be to determine if the parameter value lays in a predefined region of values or is below a threshold.

The analysis of the fitting parameter value can be done automatically. Therefore, the method to determine the time when the recovery condition is present, as it is described here, can be done automatically and the recovery can start without interaction of a user. Furthermore, it predicts the moment when the recovery is most effective.

Preferably, the determination of a recovery condition is mainly based on a certain slope of the fitting function being above a certain threshold slope.

The recovery condition is a predetermined indication that the performance of the filtration system is so low that recovery is needed. For example, in a pulsed filtration system the permeability value may be acceptable at the beginning of each cycle, but the permeability value decreases within each cycle. This decrease may be so fast that the mean permeability value over one cycle becomes very low and the filtration system filters poorly.

The slope increases the further back the last recovery was.

Optionally, the regression analysis function is a fitting function.

A fitting function is defined here as a particular embodiment of the regression analysis function, characterised in that it is based on the method of least squares. Such a function is already included in many programs and a use of such a method is also commonly known. The implementation of such a method in the system is particularly easy here.

In principle, however, other functions of regression analysis are also possible, such as Bayesian methods, percentage regression, least absolute deviations, nonparametric regression, scenario optimization, or distance metric learning.

Advantageously, the regression analysis function is one or a combination of the following functions:
an exponential function, preferably: f(t)=a*exp(−b*t)+c,
a logarithmic function, preferably: f(t)=−a*In(−b*t)+c,
a linear function, preferably: f(t)=−a*t,
a quadratic function, preferably: f(t)=−a*t\hat{ }2,
a Taylor polynomial function, preferably of degree of at least 2, of at least 3, or of at least 4,
wherein t is the time and a, b and c are the fitting parameters.

These functions are particularly suitable for describing the trend of permeability values over time. Since they describe the trend of the permeability values particularly well, the functions here are also suitable for predicting the future trends and thus reliably indicating when a recovery condition exists.

Preferably, the regression analysis function is adapted to successive permeability values by an optimization method.

In a mathematical optimization method, an attempt is made to identify the optimal parameters of the regression analysis function so that this function optimally matches the permeability values.

Optionally, the regression analysis function is the exponential function f(t)=a*exp(−b*t)+c and the decision whether a recovery condition is present is determined only by means of the fitting parameters b.

Even though parameters a and b both have an influence on the slope of the permeability function, it has been shown that parameter b alone is sufficient to indicate whether the filtration system needs to be recovered. This is explained in more detail below in the embodiment.

Advantageously, the first three steps are repeated at predetermined intervals.

In particular, these predetermined intervals are predetermined by the periodic cycles applied in periodically operated filtration systems.

The repetition can be used to periodically check whether a recovery condition is present or not.

Preferably, the determined measurement cycle in the first step is assigned to the active phase of a pulsed cycle.

If the active phase is used, the permeability can be measured in a meaningful way.

The method could be used such that wastewater is streamed in pulsed cycles across the surface of the filter membrane. The or each pulsed cycle has an active phase and an inactive phase. The advantages provided by the first aspect of the invention are associated with using this combination of an active phase and an inactive phase.

It is assumed that the nanoparticles and/or microparticles on or within the filter membrane are able to redisperse into the wastewater during the inactive phase. There is no, or nearly no, flow of wastewater over the surface of the filter membrane during the inactive phase, which allows the particles to redisperse into the wastewater. The pulse cycles may also create a localised disturbance over the surface of the filter membrane, which may also prevent the particles from settling on or within the filter membrane and/or breaks up any filter cake that is formed on or within the filter membrane.

The pulsed cycle comprises an active phase. It is preferred that the pulse cycle comprises a single active phase.

Optionally, the predetermined intervals last a maximum of 3600 seconds, preferably no more than 1200 seconds, and more preferably no more than 600 seconds.

The active phase has a duration of greater than 50% of the corresponding pulsed cycle. On the one hand, the inactive phase may reduce or prevent formation of filter cake on the filter membrane and the surface of the membrane can be kept clean. On the other hand, the inventors have also realized that the longer the active phase of the pulsed cycles and the shorter the inactive phase, the more throughput is possible, as the effective conveying time is longer per pulse. In other words, more permeate is achieved at the same pressure when the duration of the active phase is longer than the duration of inactive phase in the pulsed cycles. Thus, the extension of the active phase of the pulsed cycles compared to the inactive phase results in an increase in the efficiency of the filtering process and an overall reduction in energy consumption.

This effect results from the following relationships: During the inactive phase, some of the particles that form the filter cake go back into solution. The longer the inactive phase, the more particles dissolve in the liquid. The dissolved particles are then washed away in the active phase. With laminar flow, it is possible for a large proportion of the dissolved particles to be washed away and only a smaller proportion to be incorporated back into the filter cake. Therefore, the inactive phase should not be arbitrarily short.

Advantageously, the predetermined intervals last at least 5 seconds, preferably at least more than 30 seconds, and more preferably at least more than 100 seconds. A cross-flow filtration system can be used. During continual use of a cross-flow filtration system, the duty pressure and/or transmembrane pressure pushes particles against the filter membrane. These particles may accumulate on the surface of the filter membrane or within the filter membrane to form a filter cake of the particles. This filter cake hinders the flow of liquid into or through the filter membrane and produces an exponential reduction in the filtration rate until it reaches a plateau. At this point, filtration reaches a steady state, with the filtration rate remaining stable at the plateau level. This is the asymptotic value of the steady state mentioned below. When the filtration system reaches a steady state, then it is energetically less efficient because the same amount of energy is needed as during the initial stages of filtration, but less liquid is filtered.

Therefore, it is preferred that the active period is shorter than the time it takes for the flow throughput of permeate to drop from the maximum flow throughput of permeate in the active phase to a steady state flow throughput of permeate. The active period is preferably not more than 80% of the time needed to reach the steady state, preferably not more than 60%, more preferably not more than 50%, and even more preferably not more than 40% of the time needed to reach the steady state. The steady state is an asymptotic value which is practically never achieved. For the present invention, the time when the steady state is reached is when the flow throughput is in a range of 5% of the asymptotic value of the steady state.

This adjustment of the active phase with respect to the steady state can also be applied to other processes of cross-flow filtering a liquid by means of a pulsatile flow through a membrane, particularly through a hollow fiber membrane.

It is preferable that the active period is from 5 to 3600 seconds, such as from 10 to 2800 seconds, preferably 30 to 1800 seconds, more preferably from 60 to 1200 seconds, such as from 90 to 900 seconds, and even more preferably from 100 to 600 seconds.

The or each active phase has a duration of greater than 50% of the corresponding pulsed cycle. Thus, the active period is greater than 50% of the period of the pulsed cycle.

The inventors have found that when the active phase is longer than the inactive phase, then greater throughput of permeate is obtained, while ensuring that the cross-flow filtration is energy efficient. For the avoidance of doubt, the inactive period cannot be zero for there to be a pulsed cycle.

The duration of the active phase as a percentage of the total duration of the pulsed cycle can be expressed by the parameter known as the duty cycle. When the active period is greater than 50% of the period of the pulsed cycle, then this is equivalent to a duty cycle of greater than 50%.

The duty cycle may be greater than or equal to 51%, preferably greater than or equal to 55%, more preferably greater than or equal to 57%, such as greater than or equal to 60%, even more preferably greater than or equal to 65%, preferably greater than or equal to 70%, and most preferred is a duty cycle greater than or equal to 75%.

The duration of the active phase does not exceed 99% of the corresponding pulse cycles, preferably does not exceed 95%, more preferably does not exceed 90%, and even more preferably does not exceed 80% of the corresponding pulse cycles. In other words, the duty cycle does not exceed 99%, and preferably does not exceed 95%. More preferably, the duty cycle is less than or equal to 85%, more preferably less than or equal to 83%, such as less than or equal to 82%, even more preferably less than or equal to 81%, and most preferred is a duty cycle that is less than or equal to 80%.

Any lower limit for the duty cycle may be combined with any upper limit of the duty cycle.

The duty cycle may be greater than 50% and does not exceed 99%, preferably greater than or equal to 51% and less than or equal to 95%, more preferably greater than or equal to 55% and less than or equal to 90%, particularly greater than or equal to 55% and less than or equal to 85%, such as greater than or equal to 57% and less than or equal to 83%, particularly greater than or equal to 57% and less than or equal to 82%, even more preferably greater than or equal to 60% and less than or equal to 81%, especially greater than or equal to 65% and less than or equal to 80%, still more preferably greater than or equal to 70% and less than or equal to 80%, and most preferred is a duty cycle (D) that is greater than or equal to 75% and less than or equal to 80%.

The optimum duty cycle to provide the highest throughput of permeate, while minimizing energy when operating the pump, will depend on several factors, including the type of filter membrane, the flow rate of wastewater, the TMP, the nature of the microparticles and/or nanoparticles.

Optionally, at least 2, preferably 3, and more preferably 4 fitting parameters of the regression analysis function are determined.

In principle, each parameter increases the degree of freedom to fit the regression analysis function to the permeability values. This provides a greater opportunity to achieve accuracy in fitting the function to the permeability values.

Optionally, the methods for predicting a maintenance condition of the filtration system and for predicting a recovery condition of the filtration system are according to any of the methods for predicting a recovery condition described above, are performed at the same time.

By performing both methods at the same time, both recovery and maintenance conditions can be monitored. This allows the filtration system to be operated for a particularly long time, in that the recovery succeeds in partially restoring the original initial performance, and by predicting the maintenance condition the longest possible operation of the pump is produced.

It has been shown that the recovery does not have a significant influence on the time when the filtration system has to be maintained. Recoveries extend the duration between two maintenances.

Advantageously, the fluid is water, preferably wastewater and more preferably wastewater from a diagnostic apparatus.

The term “wastewater” as used herein refers to an aqueous solution comprising nanoparticles and/or microparticles. The wastewater is a waste product directly obtained from a diagnostic apparatus or laboratory analyser. The nanoparticles and/or microparticles are used or unused reagents from the diagnostic or laboratory analysis performed by the diagnostic apparatus or the laboratory analyser. The wastewater may include other waste or by-products from the diagnostic or laboratory analysis, such as the chemical or substance for analysis.

The terms “nanoparticles” and “microparticles” as used herein generally refer to particles having a size less than or equal to 5 mm. The microparticles have a particle size of less than or equal to 5 mm (preferably less than or equal to 1 mm) and greater than or equal to 1.0 μm. The nanoparticles have a particle size of less than 1.0 μm (e.g. 999 nm or less) to greater than or equal to 1 nm. In general, the nanoparticles and/or microparticles are reagents used in the diagnostic apparatus or the laboratory analyser.

For the avoidance of doubt, all parameters relating to the flow of the wastewater or the throughput of the permeate relate to the temperature at which the method according to the first aspect and/or the second aspect of the invention was performed, or the temperature of the operating the system of the invention. In general, the invention is performed or operated at room temperature (e.g. 20° C.). Any numerical value for a pressure refers to the pressure above atmospheric pressure, unless the context indicates otherwise.

According to a further development the filtration system is a cross-flow filtration system.

The method is specifically concerned with the cross-flow filtration of a liquid, in this case a wastewater from a diagnostic apparatus or a laboratory analyser, where the liquid is passed or conveyed across the surface of a filter membrane with a laminar flow. Nanoparticles and/or microparticles are removed from the filter membrane by size exclusion. In other words, the pore size of the filter membrane should be sufficiently small to prevent the nanoparticles and/or microparticles from entering the pores.

In the first aspect of the invention, the method comprises streaming the wastewater across the surface of the filter membrane with a flow rate, so that the flow of the wastewater is a laminar flow with a Reynolds number (Re) of less than 500. It is preferred that the flow of the wastewater is a laminar flow with a Reynolds number (Re) of less than 250, more preferably less 150, and even more preferably the Reynolds number (Re) is no more than 100, particularly 75 or less. The Reynolds number is determined at the wastewater temperature at which cross-flow filtration is to be performed.

Typically, the flow of the wastewater is a laminar flow with a Reynolds number (Re) from 1 to less than 500. It is preferred that the flow of the wastewater is a laminar flow with a Reynolds number (Re) from 5 to 250, more preferably from 10 to 150, and even more preferably the Reynolds number (Re) is from 15 to 100, particularly from 20 to 75 or from 10 to 75.

A filtration system of a diagnostic apparatus or a laboratory analyser is designed for carrying out at least one of the above mentioned methods.

In further embodiments, the present invention relates to the following aspects:
1. Method for predicting a maintenance condition of a filtration system of a diagnostic apparatus or a laboratory analyser at a given time by performing the following steps:
   a) measuring a plurality of successive raw permeability values of the permeability of a fluid through the filtration device over a specified measurement period;
   b) determining smoothed permeability values by means of a data processing method to reduce the fluctuations of the raw permeability values over time;
   c) applying a regression analysis function through the successive permeability values, wherein the regression analysis function comprises fitting parameters being adapted so that the fitting function is fitted to the measured permeability values; and
   d) determining, when the regression analysis function will cross a predetermined threshold value, wherein the crossing of the threshold value is judged as a maintenance condition.
2. Method according to aspect 1, characterized in
   that the smoothed permeability value is a moving average of the most recent two or more of the measured raw permeability values, which cover a duration of at least 1/1000, optionally at least 1/100, and optionally at least 1/10 of the average time the filtrating system is running until it has to be maintained.
3. Method according to aspect 1 or 2, characterized in
   that the smoothed permeability value is a moving average of the most recent two or more of the measured raw permeability values, which cover a duration of at least 1 minute, at least 1 day, or at least 1 week.
4. Method according to aspects 1 to 3, characterized in
   that at least the steps c) and d) are performed when the smoothed permeability value is lower than 90%, optionally lower than 70%, and optionally lower than 40%.
5. Method according to one of aspect 1 to 4, characterized in
   that at least the steps c) and d) are only performed, when the smoothed permeability values are greater than 5%, optionally higher than 10%, and optionally higher than 20%.
6. Method according to one of aspects 1 to 5, characterized in that the regression analysis function is a fitting function.
7. Method according to one of aspects 1 to 6, characterized in
   that the regression analysis function is one or a combination of the following functions:
      an exponential function, preferably: f(t)=a*exp(−b*t)+c,
      a logarithmic function, preferably: f(t)=−a*In(−b*t)+c,
      a linear function, preferably: f(t)=−a*t,
      a quadratic function, preferably: f(t)=−a*t\hat{ }2,
      a Taylor polynomial function, optionally of degree of at least 2, of at least 3, or of at least 4,
wherein t is the time and a, b and c are the fitting parameters.
8. A method for predicting a recovery condition of a filtration system of a diagnostic apparatus or a laboratory analyser at a given time by performing the following steps:
   a) measuring a plurality of successive permeability values of the permeability of a fluid through the filtration device over a specified measurement cycle;
   b) applying a regression analysis function through the successive permeability values, wherein the regression analysis function comprises fitting parameters being adapted so that the fitting function is fitted to the measured permeability values; and
   c) determining by means of the fitting parameters whether a recovery condition is present.
9. Method according to aspect 8, characterized in
   that the determination of a recovery condition is based mainly on a certain slope of the fitting function being above a certain threshold slope.
10. Method according to aspect 8 or 9, characterized in
   that the regression analysis function is a fitting function.
11. Method according to one of aspects 8 to 10, characterized in
   that the regression analysis function is one or a combination of the following functions:
      an exponential function, preferably: f(t)=a*exp(−b*t)+c,
      a logarithmic function, preferably: f(t)=−a*In(−b*t)+c,
      a linear function, preferably: f(t)=−a*t,
      a quadratic function, preferably: f(t)=−a*t\hat{ }2,
      a Taylor polynomial function, optionally of degree of at least 2, of at least 3, or of at least 4,
   wherein t is the time and a, b and c are the fitting parameters.
12. Method according to aspect 10 or 11, characterized in
   that the regression analysis function is adapted to successive permeability values by an optimization method.
13. Method according to one of aspects 11 or 12, characterized in
   that the regression analysis function is the exponential function f(t)=a*exp(−b*t)+c and the decision whether the recovery condition is present is determined only by means of the fitting parameters b.
14. Method according to one of aspects 8 to 13, characterized in
   that steps a) to c) are repeated at predetermined intervals.
15. Method according to one of aspects 8 to 14, characterized in
   that the determined measurement cycle in step a) is assigned to an active phase of a pulse cycle.
16. Method according to one of aspects 14 or 15, characterized in
   that the predetermined intervals last a maximum of 3600 seconds, optionally no more than 1200 seconds, and optionally no more than 600 seconds.
17. Method according to one of aspects 14 to 16, characterized in
   that the predetermined intervals last at least 5 seconds, optionally at least more than 30 seconds and optionally at least more than 100 seconds.
18. Method according to any one of aspects 11 to 17, characterized in
   that at least 2, optionally 3, and optionally 4 fitting parameters of the regression analysis function are determined.
19. Method according to any one of aspects 1 to 7, characterized in
   that the method according to any of claims 8 to 18 is performed at the same time.
20. Method according to any one of aspects 1 to 19, characterized in
   that the fluid is water, optionally wastewater and optionally wastewater from a diagnostic apparatus.
21. Method according to one of aspects 1 to 20, characterized in
   that the filtration system is a cross-flow filtration system.
22. Filtration system of a diagnostic apparatus or a laboratory analyser that is designed for carrying out a method according to one of aspects 1 to 21.

The invention is explained in more detail below by way of exemplary embodiments as shown in the drawings.

The drawings show schematically:

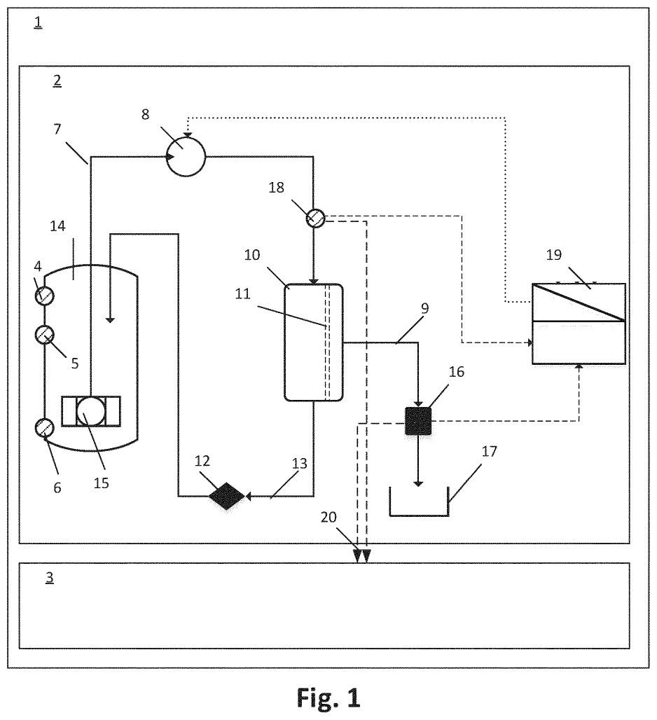

FIG. 1 a cross-flow filtration system,

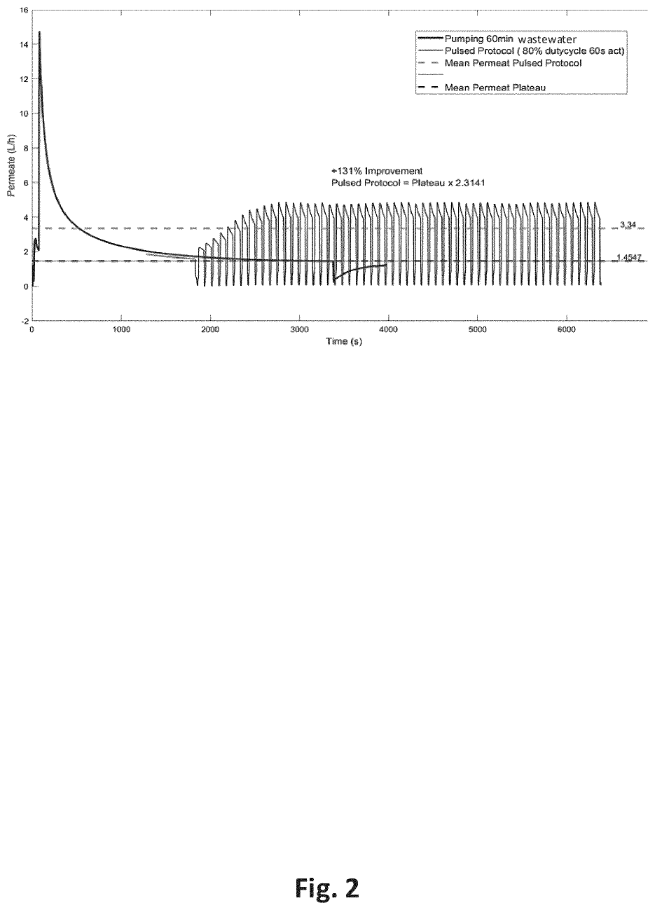

FIG. 2 a diagram of the permeability of a cross-flow filtration system in a continuous and a pulsatile modus,

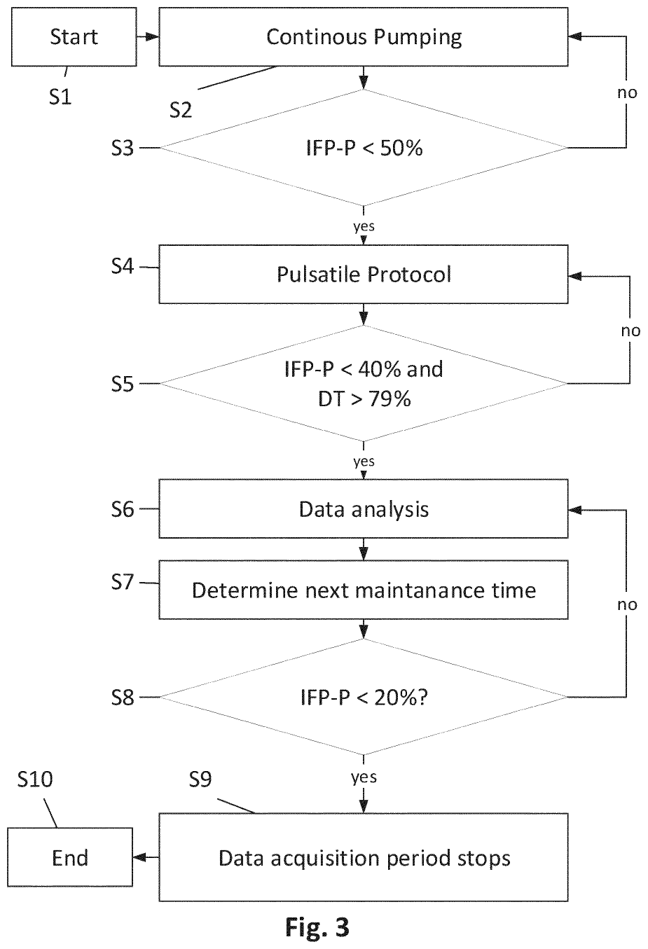

FIG. 3 a block diagram for the operation of a cross-flow filtration system,

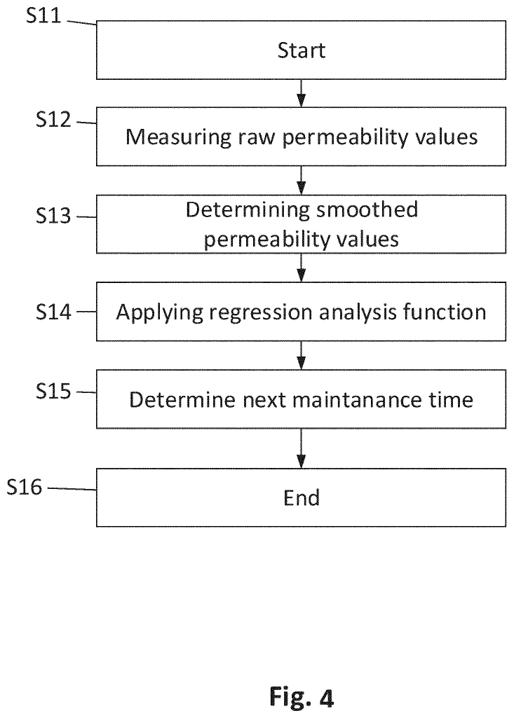

FIG. 4 a block diagram for the method to predict a maintenance condition of a filtration system,

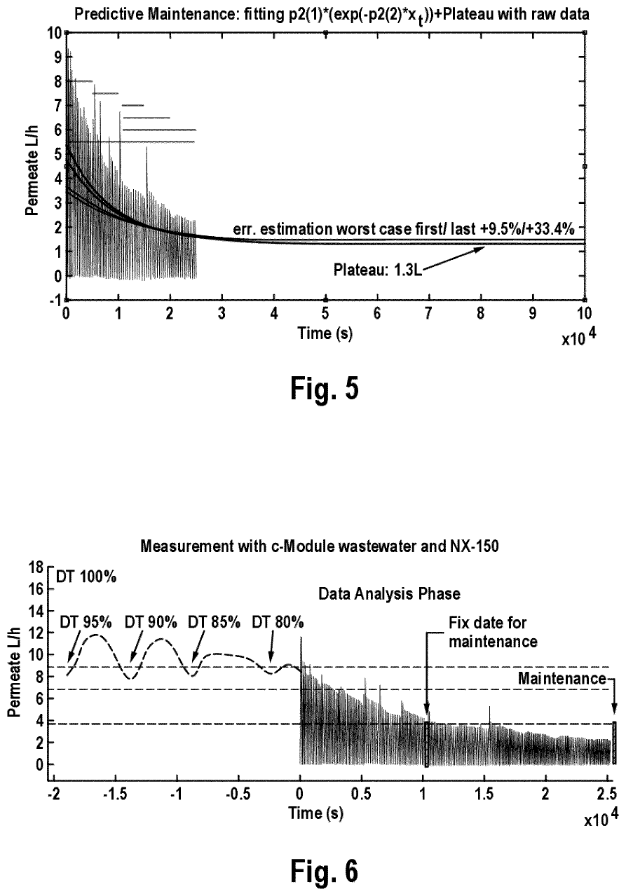

FIG. 5 a diagram of the permeability and a fitting function to predict a maintenance condition,

FIG. 6 a diagram of the permeability over time,

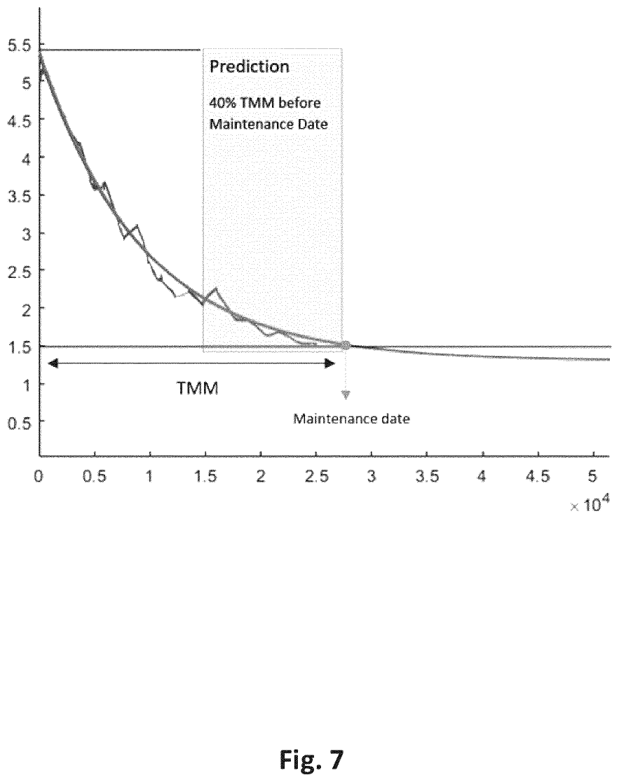

FIG. 7 a zoomed diagram of the permeability over time,

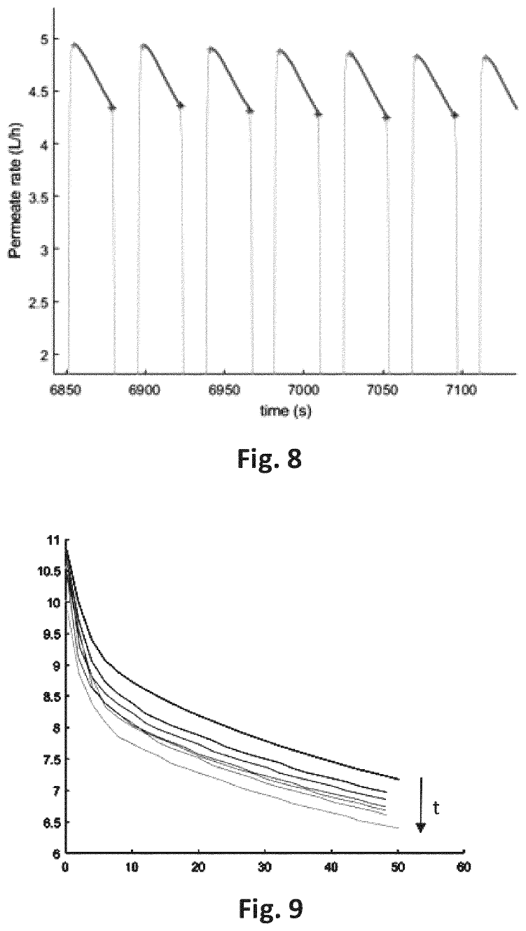

FIG. 8 a further zoomed diagram of the permeability over time of cross-flow filtration system in a pulsatile modus,

FIG. 9 fitted functions of the permeability over time show in FIG. 8,

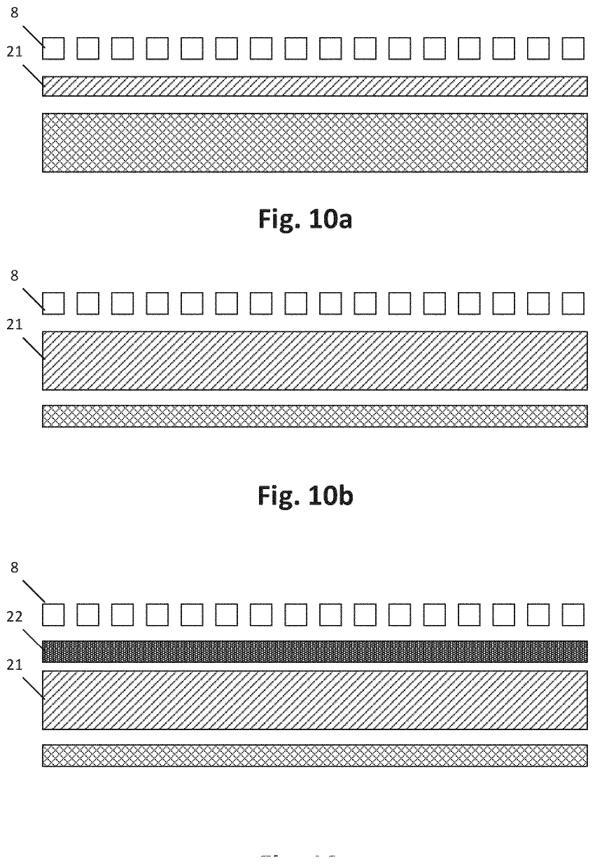

FIG. 10a a zoomed view of a section of a hollow fibre of a cross-flow filtration system with particle layers at the beginning of a duty cycle,

FIG. 10b a zoomed view of a section of a hollow fibre of a cross-flow filtration system with particle layers at the end of a duty cycle,

FIG. 10c a zoomed view of a section of a hollow fibre of a cross-flow filtration system with particle layers with a permanently damage, such as irreversible fouling processes, forming an irreversible filtration resistance

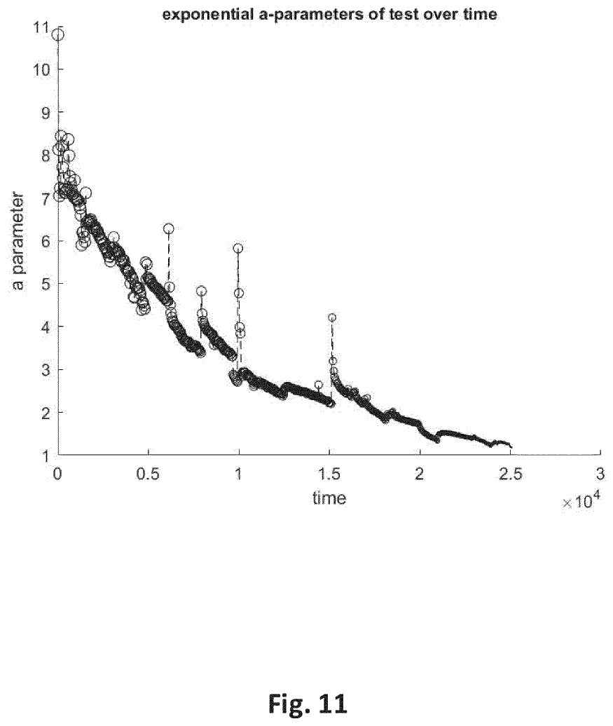

FIG. 11 diagram of the exponential a-parameters of the fitting function over time,

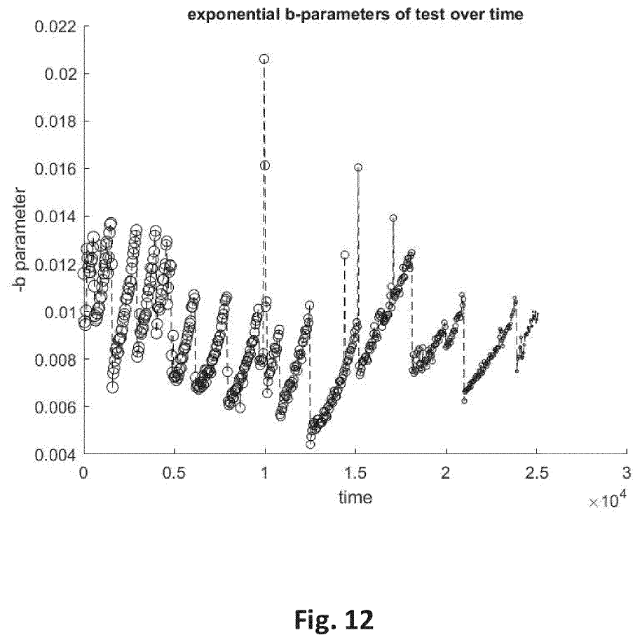

FIG. 12 diagram of the exponential b-parameters of the fitting function over time, and

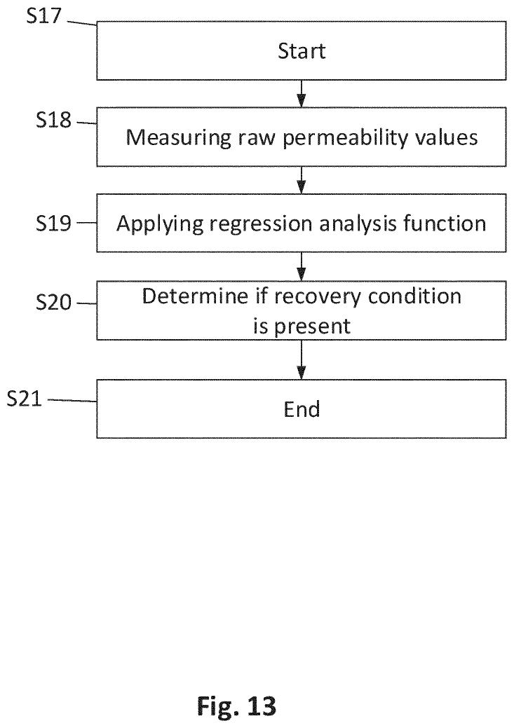

FIG. 13 a block diagram for the method to predict a recovery condition of a filtration system.

In the following, a filtration system 1 for carrying out a method for predicting a maintenance condition of the filtration system and a method for predicting a recovery condition of the filtration system is explained (FIG. 1).

The filtration system 1 comprises a filtration module 2 and an analysis module 3.

The filtration module 2 is described in detail in the unpublished European patent application 22157842.0. This patent application is incorporated herein by reference.

The filtration module 2 comprises a sensor for detecting overflow 4, a sensor for detecting a maximum fill level 5, a sensor for detecting a minimum amount of feed 6, a conduit for the feed of wastewater 7, a pump 8, a conduit for the permeate 9, a filter module 10, a filter membrane 11, a flow inhibitor, such as a pressure limiter 12, a conduit for the retentate 13, a container 14, a prefilter 15, a flow sensor 16, a permeate container 17, a sensor for detecting a flow rate of the wastewater 18, such as a flow sensor, and a controller 19, such as an electronic microcontroller.

The pressure source is a pump 8. The pump 8 draws wastewater (e.g. feed) through the conduit 7 from the container 14 through the pre-filter 15. The operation of pump 8 is controlled by the electronic microcontroller 19 via electrical coupling. The flow rate of the wastewater passing into the filter module 10 is measured by using the pressure sensor 18 which is electrically coupled to the electronic microcontroller 19. The wastewater from the pump 8 is passed or conveyed into the filter module 10 having a filter membrane 11.

If the filter membrane is not obstructed, then permeate is produced that passes into a conduit 9. The flow rate of permeate in the conduit 9 is measured using flow sensor 16. Flow sensor 16 is electrically connected to the electronic microcontroller 19 and provides information about the amount of permeate produced during filtration. The permeate passes through flow sensor 16 and may be collected in a permeate container 17.

Any wastewater from the feed that does not pass through the filter membrane 11 is retentate. The retentate leaves the filter module 10 in conduit 13 and flows into a flow inhibitor, which in this case is pressure limiter 12. Pressure limiter 12 is used to control the pressure of feed/retentate on the feed/retentate side of the filter membrane 11. From the pressure limiter 12, the retentate is returned to container 14 to be recycled as part of the liquid feed.

Signals are sent via electrical coupling to pump 8 to sequentially switch the pump on and off to produce pulsed cycles. The switching of the pump on and off controls the length of the active period and the inactive period of the pulse cycles. The magnitude of the duty pressure is determined in part by the flow output from pump 8.

The pressure within the system is monitored using the pressure sensor 18 and is adjusted using the pressure limiter 12. The pressure limiter 12 may also be used to adjust the active period and the magnitude of the pulse cycle. The active period or the duty cycle of the pulsed cycle may be varied until the flow sensor 16 detects permeate having a flow rate meeting a certain minimum threshold value. At this point, the parameters relating to the pulsed cycle may be fixed and cross-flow filtration is performed. If the flow sensor 16 detects a reduction in the flow rate of permeate below the certain minimum threshold value, then the pulsed cycle may be adjusted until the flow rate of permeate crosses the threshold value again.

The container 14 has a sensor 4 for detecting an overflow of wastewater from the container 14. The sensor 4 is electrically connected to the electronic microcontroller 19. When the sensor 4 detects that the container 14 is full, then the electronic microcontroller 19 may trigger an alarm.

The container 14 has a sensor 5 for detecting a maximum volume of wastewater in the container 14. The sensor 5 is electrically connected to the electronic microcontroller 19. When the sensor 5 detects that the volume of wastewater has reached the maximum level, then the electronic microcontroller 19 may trigger a notification. The notification may ask the end user if the cross-filtration process should be started or start the filtration automatically.

The container 14 has a sensor 6 for detecting a minimum volume of wastewater in the container 14. The sensor 6 is electrically connected to the electronic microcontroller 19. When the sensor 6 detects that the minimum volume of wastewater has been reached, then the electronic microcontroller 80 may trigger an alarm and/or the pump 10 may be switched off.

In this embodiment, the analysis module 3 is embodied as a computer on which software is stored and executable to perform the procedure for determining a maintenance condition and/or the procedure for determining a recovery condition.

The computer may be understood herein as a system having a processor and a memory. For example, a computer may be a PC, a laptop, a mobile terminal such as a mobile phone, tablet or laptop, but the computer may also represent a server or be implemented as a microcontroller. It is also conceivable that the computer is accessible as cloud applications via the internet.

The software is made up of several modules that exchange data via channels. The channels are logical data connections between the individual modules. The modules can be software modules as well as hardware modules.

The analysis module 3 is connected to the sensors of the filtration module 2 via a data link 20.

The analysis module 3 also has a display device (not shown) and a data input device (not shown) with which corresponding commands can be entered and the results, the predictions, can be output. In the simplest case, the data output is a monitor.

In the following, a process is described that roughly represents a maintenance cycle of the filtration system described above. A maintenance cycle is to be understood here as the period between two maintenance operations.

The process begins with step S1 (FIG. 3).

Subsequently, in step S2, the filtration system 1 is in a continuous pumping process. This means that the wastewater is continuously filtered (FIG. 2).

During this process, the permeability of the filtration system 1 is also measured. In this embodiment example, the flow sensor 16 and the sensor 18 measure values from which permeability values can be calculated. The sensor values are passed to the analysis module 3 for this purpose, which then performs the calculations.

The permeability is also converted into a percentage value, where 100% corresponds to a permeability performance directly after maintenance and 0% corresponds to a blockage, i.e. no filtering at all.

In step S3 it is now checked whether the percentage permeability value is less than 50%. If this is not the case, the system continues to filter continuously and after a predefined time the relative permeability is queried again.

If the relative permeability is below 50%, the pulsating protocol is applied to the filtration system in step S4 (FIG. 6).

This process is described in detail in the European patent application 22157842.0. This patent application is incorporated herein by reference.

In the next step S5, it is checked whether the relative permeability is below 40% and whether the ratio of the active time to the total time of a cycle is above 79%. If this is not the case, the pulsating protocol is applied in step S4.

If, on the other hand, the request is answered in the affirmative, the data analysis starts with step S6. This is described in more detail below. Step S7 follows, in which the next maintenance time is determined. This process is also described below.

In step S8, it is queried whether the relative permeability is below 20%. If it is not, the data analysis continues according to steps S6 and S7.

However, if the query is answered in the affirmative, data acquisition stops with step S9.

The process ends with step S10.

The following describes a process for analysing the data according to step S6 in order to determine the next maintenance condition beforehand according to step S7.

The process starts with step S11 (FIG. 4).

In step S12, the raw permeability values are measured. For this purpose, the pressures of the fluids are measured at the sensors 16 and 18 in order to determine the raw permeability values therefrom. In other embodiments other parameters such as flow or weight of the permeate container 17 could be measured as well.

In this example embodiment, a new value is determined every 10 seconds.

According to step S13, smoothed permeability values are then determined from the raw permeability values. For this purpose, the data is smoothed according to a moving average algorithm. A time window of 800 seconds is chosen for the algorithm. Here it is crucial that the window for the averaging is larger than the duration of one cycle, preferably larger than the duration of 3 cycles, and more preferably larger than the duration of 10 cycles. Only then can outliers, or deviations, which arise due to the periodic operation of the field control system be compensated. For example, very high permeability values result from the periodic operation, especially at the beginning of a cycle, while a permeability value of 0 is calculated during the non-active time.

In step S14, a regression analysis function is applied to the smoothed permeability values.

Now, usual known processes of mathematical optimisation are applied.

The function assumed here is exponential or decay:

f(t)=a*exp(−b*t)+c
wherein t is the time and a, b and c are the fitting parameters (FIG. 7).

In step S15, the next maintenance condition is determined.

For this purpose, the previously determined function with the corresponding parameters found is considered to determine a time at which a permeability of 5% will be reached.

The 5% is a predetermined value and other predetermined values that define the maintenance state as a threshold value can also be specified.

It is also conceivable that absolute permeability values, specified in e.g. Darcy or m², are specified as the threshold value.

The determined time will ideally be in the future and can then be communicated to a user accordingly.

Thereupon, appropriate measures can be taken so that maintenance can take place at the corresponding time, so that the corresponding downtimes are minimised and/or the maintenance takes place in a period that is considered acceptable for the user. This includes, for example, appropriate holiday periods or at night.

The process ends with step S16.

The following describes a process for determining the recovery condition.

The process starts with step S17 (FIG. 13).

In step S18 the raw permeability values are determined. This is done in the same way as described in step S12.

In the following step S19, a regression analysis function is applied from the measured raw permeability values. Essentially, the application of this function corresponds to step S14, whereby in this process the raw permeability values are used.

According to this example embodiment, only the data of the active phase of a single cycle from the pulsating operation of the filtration system are used here.

The function here also corresponds to the exponential function explained in step S14.

Through a mathematical optimisation algorithm, the corresponding function is applied to the data.

This gives an a-parameter value and a b-parameter value. Both are related to the slope of the function. In FIG. 8 several slopes of different cycles are shown. In FIG. 9 the corresponding fitted functions with the resulting a and b-parameter values are shown.

The c parameter is a constant and has been given as a value in this embodiment example.

The inventors have realised that there are physical principles associated with both the a and b-parameter values.

If the resulting a-parameter value is plotted over a number of cycles, it can be seen that the a-parameter value steadily decreases over time.

The a-parameter value is thus associated with a steadily deteriorating filtration system that cannot be remedied by recovery (see FIG. 11).

The b-parameter value, on the other hand (see FIG. 12), falls with increasing distance to the last recovery (the negative b-parameter value is plotted in the figure).

With each new recovery, the b-parameter value drops again, resulting in the zigzag behaviour shown in FIG. 12.

This can be explained by looking at how the different particles attach to the membrane 11. In the case of a refreshed membrane shortly after maintenance and recovery, no or very few particles are found on the membrane 11 (see FIG. 10a).

These light particles form a thin removable film 21 through which the wastewater can still flow.

The removable film 21 can be dissolved again by recovery.

However, if more and more recovery cycles have been carried out and maintenance has not occurred for an extended period of time, a thick film 21 continues to build up (see FIG. 10 B).

At some point, however, the recovery will not be sufficient to detach all the detachable film 21 from the filter membrane 11. A permanent irreversible film 22 will then build up on the membrane 11. This may result in permanent damage and fouling to the membrane 11.

The inventors have found that the irreversible film can also result from decomposition processes, for example particles in the pores, and that a measure of these irreversible processes is given by the a-parameter value.

The b-parameter value refers to a thickness of the removable film 21.

In step S20, it is determined whether a recovery condition exist.

For this purpose, the recovery condition is determined when the b-parameter value is below a predetermined threshold value. In the example embodiment, it is preferably −0.01 here.

The process ends with step S21.

In an alternative embodiment, the maintenance condition can also be determined by the process, which is used to determine the recovery condition by considering when a-parameter value is or will be below a predetermined threshold value.

Here, an additional adjustment of the trend of the a-parameter values over several cycles is necessary. From the additional fitted function against the several a-parameter values, it can be determined when the a-parameter value will fall below a certain threshold value.

Here, an exponential function is also advantageous as a fitted function.

List of References

| | |
|---|---|
| 1 | filtration system |
| 2 | filtration module |
| 3 | analysis module |
| 4 | overflow sensor |
| 5 | maximum fill level sensor |
| 6 | detecting a minimum amount of feed sensor |
| 7 | conduit for the feed of wastewater |
| 8 | pump |
| 9 | conduit for the permeate |
| 10 | filter module |
| 11 | filter membrane |
| 12 | pressure limiter |
| 13 | conduit for the retentate |
| 14 | container |
| 15 | prefilter |
| 16 | flow sensor |
| 17 | permeate container |
| 18 | sensor for detecting a flow |
| | rate of the wastewater |
| 19 | controller |
| 20 | data link |
| 21 | thin removable film |
| 22 | permanent irreversible resistance |

1. A method for predicting a maintenance condition of a filtration system of a diagnostic apparatus or a laboratory analyser at a given time by performing the following steps:
a) measuring a plurality of successive raw permeability values of the permeability of a fluid through the filtration device over a specified measurement period;
b) determining smoothed permeability values by means of a data processing method to reduce the fluctuations of the raw permeability values over time;
c) applying a regression analysis function through the successive permeability values, wherein the regression analysis function comprises fitting parameters being adapted so that the fitting function is fitted to the measured permeability values; and
d) determining when the regression analysis function will cross a predetermined threshold value, wherein the crossing of the threshold value is judged as a maintenance condition.

2. The method according to claim 1, wherein
the smoothed permeability value is a moving average of the most recent two or more of the measured raw permeability values, which cover a duration of at least 1/1000, optionally at least 1/100, and optionally at least 1/10 of the average time the filtrating system is running until it has to be maintained.

3. The method according to claim 1, wherein
the smoothed permeability value is a moving average of the most recent two or more of the measured raw permeability values, which cover a duration of at least 1 minute, at least 1 day, or at least 1 week.

4. The method according to claim 1, wherein
at least the steps c) and d) are performed when the smoothed permeability value is lower than 90%, optionally lower than 70%, and optionally lower than 40%.

5. The method according to claim 1, wherein
at least the steps c) and d) are only performed when the smoothed permeability values are greater than 5%, optionally higher than 10%, and optionally higher than 20%.

6. The method according to claim 1, wherein
the regression analysis function is a fitting function.

7. The method according to claim 1, wherein
the regression analysis function is one or a combination of the following functions:
an exponential function: f(t)=a*exp(−b*t)+c,
a logarithmic function: f(t)=−a*In(−b*t)+c,
a linear function: f(t)=−a*t,
a quadratic function: f(t)=−a*t\hat{ }2,
a Taylor polynomial function, optionally of degree of at least 2, of at least 3, or of at least 4,
wherein t is the time and a, b, and c are the fitting parameters.

8. A method for predicting a recovery condition of a filtration system of a diagnostic apparatus or a laboratory analyser at a given time by performing the following steps:
a) measuring a plurality of successive permeability values of the permeability of a fluid through the filtration device over a specified measurement cycle;
b) applying a regression analysis function through the successive permeability values, wherein the regression analysis function comprises fitting parameters being adapted so that the fitting function is fitted to the measured permeability values; and
c) determining by means of the fitting parameters whether a recovery condition is present.

9. The method according to claim 8, wherein
the determination of a recovery condition is based mainly on a certain slope of the fitting function being above a certain threshold slope.

10. The method according to claim 8, wherein
the regression analysis function is the exponential function f(t)=a*exp(−b*t)+c and the decision whether the recovery condition is present is determined only by means of the fitting parameters b.

11. The method according to one claim 8, wherein
the determined measurement cycle in step a) is assigned to an active phase of a pulse cycle.

12. (canceled)

13. The method according to claim 1, wherein
the fluid is wastewater from a diagnostic apparatus.

14. The method according to claim 1, wherein
the filtration system is a cross-flow filtration system.

15. A filtration system of a diagnostic apparatus or a laboratory analyser, wherein the filtration system
is designed for carrying out the method according to claim 1.

16. The method according to claim 8, wherein the fluid is wastewater from a diagnostic apparatus.

17. The method according to claim 8, wherein the filtration system is a cross-flow filtration system.

18. A filtration system of a diagnostic apparatus or a laboratory analyser, wherein the filtration system is designed for carrying out the method according to claim 8.
